(19) United States
(12) Patent Application Publication
(10) Pub. No.: US 2019/0206092 A1
(43) Pub. Date: Jul. 4, 2019

(54) IMAGE PROCESSING METHOD AND SYSTEM USING THE SAME

(71) Applicant: Fingram Co.,Ltd., Yongin-si (KR)

(72) Inventor: Young Cheul WEE, Suwon-si (KR)

(21) Appl. No.: 16/237,301

(22) Filed: Dec. 31, 2018

(30) Foreign Application Priority Data
Jan. 2, 2018 (KR) 10-2018-0000204

(51) Int. Cl. G06T 9/20

(52) U.S. Cl. CPC G06T 9/20

(57) ABSTRACT

An image processing method, including: checking pixel data of at least one influencing pixel of a first pixel in an image, the at least one influencing pixel including pixels surrounding around the first pixel; determining the quantization/inverse quantization values of the first pixel based on the pixel data of the at least one influencing pixel through the image processing system, and performing quantization/inverse quantization for the first pixel.

### CROSS REFERENCE TO RELATED APPLICATION

This application claims priority from and the benefit of Korean Patent Application No. 10-2018-0000204, filed on Jan. 2, 2018, which is hereby incorporated by reference for all purposes as if fully set forth herein.

### BACKGROUND

### Field

Exemplary embodiments/implementations of the invention relate generally to an image processing method and system that is capable of performing different quantization by pixel and further performing decoding, even while quantization values by pixel are being not stored.

### Discussion of the Background

As qualities of images have been improved, recently, image compression technology becomes an important issue in association with an application system using images or network traffic.

Generally, quantization is used as one of compression ways for reducing the size of an image.

Usually, the quantization is performed in the unit of a given block. For example, the entire image may be quantized to the same degree through one quantization table, and for another example, it may be quantized by block to different degrees.

In any case, information regarding the quantization values (quantization tables) should be included and stored in the compressed image. At the time when decoding is implemented, accordingly, inverse quantization can be performed with the quantization values. Like this, in case where one quantization table is used for the entire image or different quantization values (quantization tables) are used by block, decrement in compression performance is relatively weak even though the information regarding the quantization values is separately stored.

In case where quantization for pixels having different quantization values from each other is performed, however, storing the information on the quantization values of all of the pixels has a negative influence on the compression performance.

Although it is desirable that the quantization is performed by pixel, the quantization by pixel is not satisfactorily utilized in the image compression.

The above information disclosed in this Background section is only for understanding of the background of the inventive concepts, and, therefore, it may contain information that does not constitute prior art.

### SUMMARY

Methods according to exemplary implementations of the invention are capable of providing an image processing method and system that is capable of performing different quantization by pixel. Particularly, exemplary embodiments provide a technical idea that does not store information about quantization values while performing quantization for each pixel that can vary the degree of quantization in proportion to the image characteristics around each pixel, thereby enhancing compression performance against visual quality.

Additional features of the inventive concepts will be set forth in the description which follows, and in part will be apparent from the description, or may be learned by practice of the inventive concepts.

According to one or more embodiments of the invention, an image processing method includes: checking pixel data of at least one influencing pixel of a first pixel in an image, the at least one influencing pixel including pixels surrounding around the first pixel; determining the quantization/inverse quantization values of the first pixel based on the pixel data of the at least one influencing pixel through the image processing system; and performing quantization/inverse quantization for the first pixel.

The at least one influencing pixel may be a decoding precedent pixel to the first pixel, the decoding precedent pixel being decoded before decoding the first pixel of the image.

The determining the quantization/inverse quantization values of the first pixel may include determining the quantization/inverse quantization values of the first pixel in proportion to a degree of complexity of an area corresponding to the influencing

The image processing method may further include: checking pixel data of at least one secondary influencing pixel of a subsequent pixel in the image, the subsequent pixel being quantized/inversely quantized directly after the quantization of the first pixel and the at least one secondary influencing pixel including pixels surrounding around the subsequent pixel; and determining the quantization/inverse quantization values of the subsequent pixel based on the pixel data of the at least one secondary influencing pixel through the image processing system.

The image processing system may perform a non-transformation process for the pixel data of the image.

According to one or more embodiments of the invention, an image processing method includes: checking pixel data of at least one influencing pixel including decoding precedent pixels to a first pixel in an image; determining quantization/inverse quantization values of the first pixel based on the pixel data of the at least one influencing pixel through the image processing system; and performing quantization/inverse quantization for the first pixel.

According to one or more embodiments of the invention, a non-transitory computer-readable storage medium has stored thereon processor-executable instruction configured to cause a processor to perform the image processing.

According to one or more embodiments of the invention, an image processing system includes: a processor; and a memory configured to store a processor-executable instruction, wherein the processor-executable instruction is configured to cause a processor to: check pixel data of at least one influencing pixel of a first pixel in an image, the at least one influencing pixel including pixels surrounding around the first pixel; determine the quantization/inverse quantization values of the first pixel based on the pixel data of the at least one influencing pixel; and perform quantization/inverse quantization for the first pixel.

According to one or more embodiments of the invention, an image processing system includes: a processor; and a memory configured to store a processor-executable instruction, wherein the processor-executable instruction is configured to cause a processor to: check pixel data of at least one influencing pixel including decoding precedent pixels to a first pixel in an image; determine quantization/inverse quantization values of the first pixel based on the pixel data of the at least one influencing pixel; and perform quantization/inverse quantization for the first pixel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a block diagram showing an image processing system according to an exemplary embodiment.

FIG. 2 is a flowchart showing an image processing method according to the exemplary embodiment.

FIGS. 3, 4, and 5 show image processing in the image processing system according to the exemplary embodiment.

FIG. 6 shows a process of decoding the compressed image according to the exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As is customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

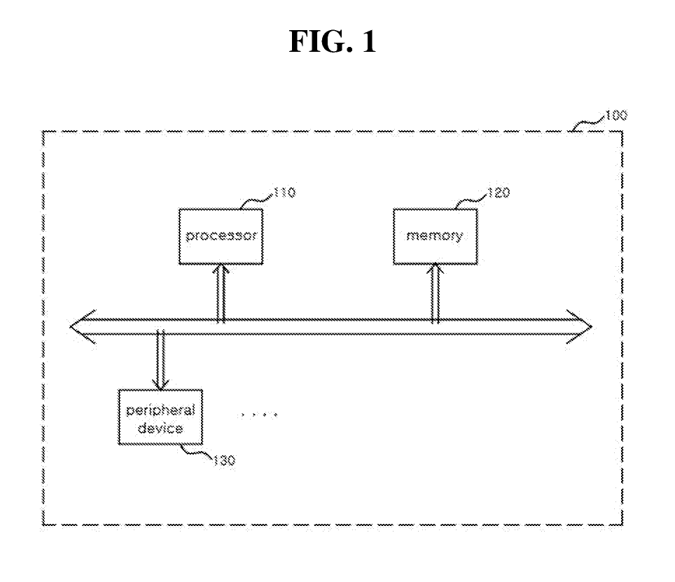

FIG. 1 is a block diagram showing an image processing system according to the exemplary embodiment.

As shown in FIG. 1, the image processing system 100 according to the exemplary embodiment includes a processor 110, and a memory 120.

The memory 120 stores a computer program (software) for implementing the technical idea of the exemplary embodiment.

The software is activated by the processor 110 to perform an image processing method according to the exemplary embodiment.

According to the exemplary embodiment, further, the image processing system 100 may include at least one peripheral device 130. For example, the peripheral device 130 includes a display device, a speaker, an audio/video processing module, an external memory, an input/output device, and so on.

The image processing system 100 refers to a data processing device capable of encoding and decoding an image, such as a desktop computer, set-top box, laptop, mobile phone, TV, server, and so on.

The image processing system 100 processes a given original image to produce a compressed image having a compressed format according to the technical idea of the exemplary embodiment.

Further, the image processing system 100 decodes the compressed image according to the technical idea of the exemplary embodiment to display the decoded image.

In any case, various data processing devices for processing the image according to the technical idea of the exemplary embodiment can be used as the image processing system 100. Also, the processing for the image through the image processing system 100 includes processing for video consisting of a plurality of images, which will be easily understood by a person having ordinary skill in the art.

For the convenience of the description, hereinafter, the exemplary embodiment will be described with the explanation wherein functions or operations of the software installed in the memory 120 and activated by the processor 110 are performed by the image processing to system 100.

The image processing system 100 according to the exemplary embodiment is a system for compressing the image to produce the compressed image or for performing quantization for producing the compressed image.

As mentioned above, the image processing system 100 can perform quantization by each pixel.

In the description, a notation quantization/inverse quantization refers to, if there is a need to perform quantization (for example, encoding for producing a compressed image), the quantization is performed, or if there is a need to perform inverse quantization (for example, decoding for the encoded image), the inverse quantization is performed.

Accordingly, the image processing system 100 according to the exemplary embodiment determines quantization/inverse quantization values on the basis of pixel data of influencing pixels of a given pixel.

In exemplary embodiments, the image processing system 100, the processor 110, the memory 120, the at least one peripheral device 130, and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to one or more exemplary embodiments, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, the image processing system 100, the processor 110, the memory 120, the at least one peripheral device 130, and/or one or more components thereof may include or otherwise be associated with one or more memories (not shown) including code (e.g., instructions) configured to cause the image processing system 100, the processor 110, the memory 120, the at least one peripheral device 130, and/or one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CD-RW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

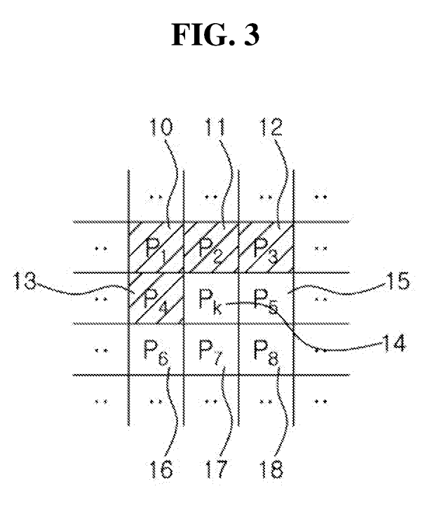

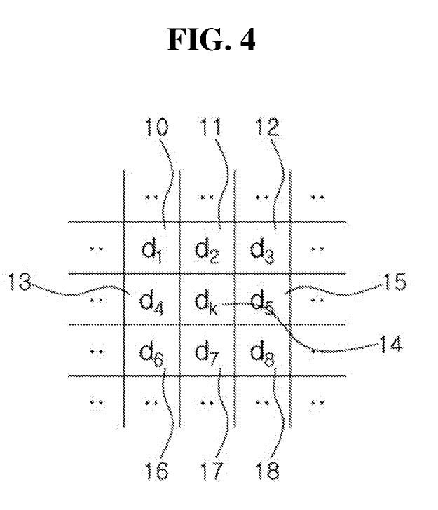

First, the process of determining the quantization and inverse quantization values will be described with reference to FIGS. 3 and 4. As shown in FIGS. 3 and 4, the exemplary embodiment can perform the quantization for each pixels in the image.

FIG. 3 shows the case where pixel data of the pixels are pixel values Pₖ, and FIG. 4 shows the case where pixel data of the pixels are differential values dₖ of the pixel values Pₖ.

The exemplary embodiment can be applicable to FIGS. 3 and 4.

First, as shown in FIGS. 3 and 4, it is assumed that the given pixels 10, 11, 12, 13, 14, 15, 16, 17, and 18 are located on original images. In this case, the pixel data of the pixels may be represented with the pixel values Pₖ or differential values dₖ. The differential value dₖ is defined as a difference value between the pixel value Pₖ of the corresponding pixel and a prediction value pred(Pₖ) of the corresponding pixel.

Referring first to FIG. 3, the image processing system 100 performs the quantization for the pixels sequentially. In FIG. 3, for example, it is assumed that the quantization is performed in the order of pixels 10, 11, and 12 and in next row, also, the quantization is performed in the order of pixels 13, 14, and 15. That is, the image processing system 100 performs the quantization by pixel from the left top to right side of the image sequentially.

After that, the image processing system 100 determines the quantization value for quantizing the given first pixel 14. At this time, the image processing system 100 determines the quantization value of the first pixel 14 on the basis the pixel data of at least one of the surrounding pixels (for example, 10, 11, 12, 13, 15, 16, 17, and 18) around the first pixel 14.

For example, the image processing system 100 checks the pixel data of a influencing pixel used in determining the quantization value of the first pixel 14 among the surrounding pixels (for example, 10, 11, 12, and 13 and 15, 16, 17, and 18) around the first pixel 14.

The influencing pixel may be a pixel set in advance to be used in determining the quantization value of the first pixel 14. Further, the influencing pixel is at least one selected from the surrounding pixels (for example, 10, 11, 12, and 13 and 15, 16, 17, and 18).

For example, the influencing pixel may be a decoding precedent pixel to the first pixel 14, and the decoding precedent pixel is a pixel decoded before the first pixel 14 when the image is decoded.

When the decoding is implemented, in detail, the pixel decoded before the first pixel 14, that is, at least one of the decoding precedent pixels is determined as the influencing pixel. In the same manner as quantization, for example, decoding may be performed by pixel from the left top to right side of the image sequentially. In this case, the decoding precedent pixels to the first pixel 14 may be the pixels 10, 11, 12, and 13.

For example, the image processing system 100 may select all of the decoding precedent pixels 10, 11, 12, and 13, as the influencing pixels, among the surrounding pixels (for example, 10, 11, 12, and 13 and 15, 16, 17, and 18) as the influencing pixels. For another example, the image processing system 100 may select a part of the decoding precedent pixels 10, 11, 12, and 13, as the influencing pixels.

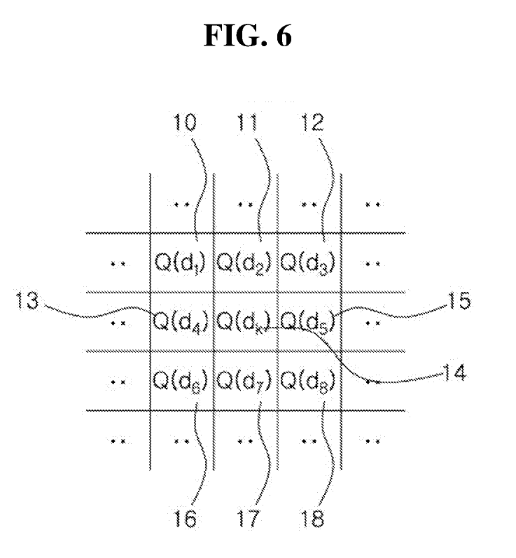

The reason why the decoding precedent pixels are determined as the influencing pixels, as described later with FIG. 6, is that as the decoding precedent pixels are already decoded before the first pixel 14, the inverse quantization value of the first pixel 14 can be operated using the pixel data of the decoding precedent pixels decoded.

If the quantization value of the first pixel 14 is determined based on the pixel data of the decoding precedent pixels, the quantization value of each pixel can be determined, without separately storing the quantization value of the corresponding pixel.

Accordingly, the image processing system 100 determines the quantization value of the first pixel 14 on the basis of the pixel data of the influencing pixels.

The image processing system 100 may determine the quantization value in proportion to the image complexity of the area corresponding to the first pixel 14 and the influencing pixels (for example, at least one of pixels 10, 11, 12, and 13).

The image complexity is a parameter indicating a degree of complexity of the image area, and generally, the bigger a difference between the pixel values of the pixel and the surrounding pixels is, the higher a degree of the image complexity of the surrounding area around the given pixel becomes. If the difference between the pixel values of the pixel and the surrounding pixels is small, that is, if the similar pixel values exist continuously, the image area having a few image variations becomes simple, and the image complexity is relatively low.

Even if relatively high compression is performed on the area having high image complexity, that is, even if the quantization value is high, it does not have a great affect on a quality of visual image. Accordingly, the quantization value is set proportional to the image complexity.

A method for calculating the image complexity of the area corresponding to the influencing pixels (for example, at least one of pixels 10, 11, 12, and 13) is carried out in various ways through the image processing system 100. For example, the image complexity can be processed using the average, deviation, or variance of differences between the pixel values (for example, abs(p1-p2), abs(p2-p3), abs(pe-p4), abs(p4-p1), here, abs( ) means absolute value) of the influencing pixels (for example, at least one of pixels 10, 11, 12, and 13).

In any case, the quantization value of the first pixel 14 can be defined as a given function with the pixel values (for example, P₁, P₂, P₃, and P₄) of the influencing pixels (for example, at least one of pixels 10, 11, 12, and 13) as parameters. In this case, the pixel data of the first pixel 14 may not be most desirable parameter for determining the quantization value, because the quantization value of the first pixel 14 can be obtained in the decoding process, and the pixel data of the first pixel 14 may not be recognized when the quantization values of the pixels quantized are not stored separately.

As the exemplary embodiments uses the decoding precedent pixels as the influencing pixels, as mentioned above, the image processing system 100 does not use a predetermined transformation. For example, in Discrete Cosine Transform (DCT) or Fourier transform, in detail, coefficients are operated at a time by block, so that if it is desired to quantize a given pixel, the pixel data of the decoding precedent pixels may not be readily recognized in advance to be used in obtaining the pixel data of the first pixel 14.

According to the exemplary embodiment, therefore, the image processing system 100 does not transform the pixel value into a frequency domain so as to implement compression, but implements the compression on the basis of the pixel data based on pixel value.

According to the exemplary embodiments, the pixel data quantized by the image processing system 100 is not limited to the pixel values as mentioned in FIG. 3. For example, as shown in FIG. 4, the pixel data quantized may be the differential values dₖ.

Even in case where the pixel data may be the differential values dₖ, as shown in FIG. 4, the image process system 100 may perform the quantization in the same manner as in FIG. 3.

In detail, the quantization value of the first pixel 14 can be determined on the basis of the pixel data (for example, d₁ to d₄) of the influencing pixels (for example, at least one of pixels 10, 11, 12, and 13) among the surrounding pixels (for example, 10, 11, 12, and 13 and 15, 16, 17, and 18) around the first pixel 14.

After the quantization value of the first pixel 14 has been determined, of course, the image processing system 100 performs the quantization of the first pixel 14. Further, the image processing system 100 can determine the quantization value of a subsequent pixel (for example, 15) from the first pixel 14 in the same manner as above. In other words, the quantization value of the subsequent pixel 15 can be determined on the basis of pixel data of a secondary influencing pixels among the surrounding pixels around the subsequent pixel 15. In detail, the image processing system 100 checks the pixel data of the influencing pixels of the subsequent pixel 15 and determines the quantization value of the subsequent pixel 15 on the basis of the pixel data of the influencing pixels of the subsequent pixel 15.

The subsequent pixel (for example, 15) from the first pixel 14 refers to the pixel quantized just after the first pixel 14 has been quantized. In a similar manner, in the decoding process, the subsequent pixel from the first pixel 14 refers to the pixel inversely quantized just after the first pixel 14 has been inversely quantized.

As a result, the image processing system 100 determines the quantization values of the respective pixels, individually of each other.

Furthermore, the image processing system 100 according to the exemplary embodiments is not limited to using only the directly adjacent pixels to the first pixel 14 as the surrounding pixels around the first pixel 14, as shown in FIGS. 3 and 4.

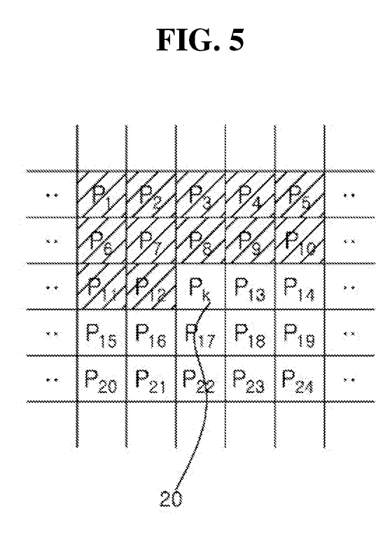

In detail, as shown in FIG. 5, the surrounding pixels around a given first pixel 20 are defined as the directly adjacent pixels (for example, P₇, P₈, P₉, P₁₂, P₁₃, P₁₆, P₁₇, and P₁₈) to the first pixel 20 as well as secondary adjacent pixels (that is, pixels P₁, P₂, P₃, P₄, P₅, P₆, P₁₀, P₁₁, P₁₄, P₁₅, P₁₉, P₂₀, P₂₁, P₂₂, P₂₃, and P₂₄, which are directly adjacent pixels to the directly adjacent pixels of the first pixel 20).

Similar to this, the influencing pixels may exist in the surrounding pixels (for example, P₁, P₂, P₃, P₄, P₅, P₆, P₇, P₈, P₉, P₁₀, P₁₁, P₁₂, P₁₃, P₁₄, P₁₅, P₁₆, P₁₇, P₁₈, P₁₉, P₂₀, P₂₁, P₂₂, P₂₃, and P₂₄) including the secondary adjacent pixels, and as mentioned above, the influencing pixels may be the decoding precedent pixels of the surrounding pixels(P₁, P₂, P₃, P₄, P₅, P₆, P₇, P₈, P₉, P₁₀, P₁₁, P₁₂, P₁₃, P₁₄, P₁₅, P₁₆, P₁₇, P₁₈, P₁₉, P₂₀, P₂ᵢ, P₂₂, P₂₃, and P₂₄). In FIG. 5, the decoding precedent pixels to the first pixel 20 in the surrounding pixels (P₁, P₂, P₃, P₄, P₅, P₆, P₇, P₅, P₉, P₁₀, P₁₁, P₁₂, P₁₃, P₁₄, P₁₅, P₁₆, P₁₇, P₁₈, P₁₉, P₂₀, P₂₁, P₂₂, P₂₃, and P₂₄) including the secondary adjacent pixels are the hatched pixels (for example, at least one of P₁, P₂, P₃, P₄, P₅, P₆, P₇, P₈, P₉, P₁₀, P₁₁, and P₁₂).

Accordingly, the image processing system 100 makes use of, as the influencing pixels, all or some of the decoding precedent pixels among the surrounding pixels (P₁, P₂, P₃, P₄, P₅, P₆, P₇, P₈, P₉, P₁₀, P₁₁, P₁₂, P₁₃, P₁₄, P₁₅, P₁₆, P₁₇, P₁₈, P₁₉, P₂₀, P₂₁, P₂₂, P₂₃, and P₂₄) around the first pixel 20.

If the quantization value of the first pixel 14 is determined like this, on the other hand, the image processing system 100 can perform decoding, even while the information on the quantization value is being not stored therein.

An example will be explained with reference to FIG. 6.

FIG. 6 shows a process of decoding the compressed image according to the exemplary embodiment.

As shown in FIG. 6, the quantization values of the each of pixels (for example, 10 to 18) are determined in the same manner as mentioned in FIGS. 3 and 4, so that the pixels are quantized. Of course, actual compressed image may be performed Huffman coding or like, which encode the quantized pixel data, but in this case, in FIG. 6. it is assumed that Huffman decoding for the quantized pixel data is already implemented.

Accordingly, the respective pixels in the compressed image as shown in FIG. 6 have the quantized pixel data Q(dₖ).

Further, the pixels in the compressed image may be decoded sequentially in their quantized order as mentioned in FIGS. 3 and 4.

According to the exemplary embodiments, before decoding the first pixel 14, the decoding precedent pixels (for example, 10, 11, 12, and 13) to the first pixel 14 have been already decoded. In other words, the image processing system 100 has already decoded and recognized the pixel values (P′ₖ, which indicate pixel values recovered after decoded) of the decoding precedent pixels (for example, 10, 11, 12, and 13).

So as to decode the first pixel 14, accordingly, the image processing system 100 performs a process for obtaining the pixel value P′ₖ of the first pixel 14 as follows.

Since dₖ=Pₖ−pred(Pₖ), P′ₖ=d′ₖ+pred(Pₖ). In this case, d′ₖ indicates recovered differential values dₖ.

If dₖ and pred(Pₖ) are obtained, accordingly, the image processing system 100 can obtain the pixel value P′ₖ.

Since d′ₖ=Q⁻¹Q(dₖ), at this time, the inverse quantization value should be obtained so as to perform the operation of Q⁻¹. At this time, the quantization value of the first pixel 14 is determined on the basis of the influencing pixels (for example, at least one of pixels 10, 11, 12, and 13), and since the influencing pixels (for example, at least one of pixels 10, 11, 12, and 13) are the decoding precedent pixels, they are already decoded, which are thus recognized through the image processing system 100.

While the quantization is being implemented the quantization values of the given pixel is determined based on the pixel data of the influencing pixels (for example, at least one of pixels 10, 11, 12, and 13), the quantization values of given pixel can be recognized in the same manner, and if quantization value of the given pixel is recognized, their inverse quantization can be implemented with the same values. That is, the inverse quantization values can be recognized.

Further, the pred(Pₖ) is recognized with the precedent pixels decoded, and if the inversely quantized value d′ₖ is added to the value pred(Pₖ), the pixel value P′ₖ can be obtained.

While the quantization is being implemented, accordingly, there is no need to separately store the quantization values of each pixel, so that even if different quantization by pixel is implemented, the compression performance may not be decreased.

By this reason, when the quantization for the first pixel 14 is implemented, if the quantization value of the first pixel 14 is just determined on the basis of the decoding precedent pixels to the first pixel 14, then it is possible to perform the decoding even if the quantization values by pixel are not stored.

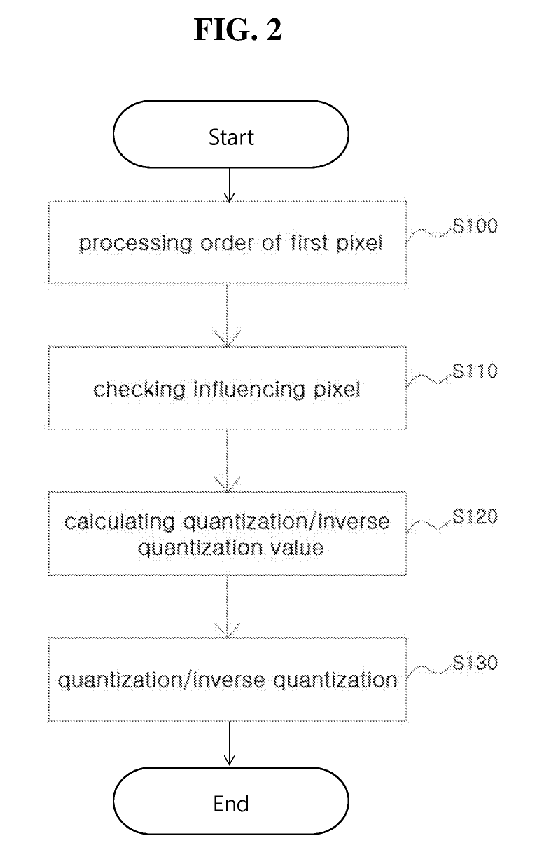

In summary, an image processing method according to the exemplary embodiment is carried out, as shown in FIG. 2.

FIG. 2 is a flowchart showing the image processing method according to the exemplary embodiment.

As shown in FIG. 2, in case of the processing (quantization or inverse quantization) order for a first pixel in a given image (step S100), the pixel data of the influencing pixels of the first pixel is checked by means of the image processing system (step S110).

The influencing pixels are all or some of the decoding precedent pixels to the first pixel. Also, theoretically, the influencing pixels are not limited to the surrounding pixels directly adjacent around the first pixel. Only if all or some of the decoding precedent pixels to the first pixel are used as the influencing pixels, the following inverse quantization can be performed, without the quantization values by pixel separately stored.

If the pixel data of the influencing pixels of the first pixel is checked, the quantization value of the first pixel is determined through the image processing system 100 on the basis of the pixel data of the influencing pixels, at the time of the compression, and the inverse quantization value (which is substantially same as the quantized value of the corresponding pixel) of the first pixel is determined through the image processing system 100 on the basis of the pixel data of the influencing pixels, at the time of the decoding (step S120).

After that, the quantization or inverse quantization can be performed through the image processing system 100 (step S130).

According to the exemplary embodiments, it is possible to perform individual quantization by pixel, thereby achieving efficient quantization by pixel to the maximum, and further, there is no need to separately store the quantization values by pixel, thereby remarkably suppressing the decrement in the compression performance.

According to the exemplary embodiments, further, the image processing method is applicable to various application solutions for displaying images or for storing, producing or editing images, and in this case, the processing for the images may include processing for video with a plurality of images.

As described above, exemplary embodiments implement the quantization by pixel, and degrees of the quantization are different in proportion to the image features of the surrounding pixels around each pixel, and the information on the quantization values is not stored, thereby enhancing the compression performance against a quality of visual image.

The image processing method according to the exemplary embodiment is to provided in a program command readable by a computer and is stored in computer readable storage medium. A control program and an object program according to the exemplary embodiment are stored in the computer readable storage medium. The computer readable storage medium includes all kinds of recording devices in which data readable by a computer system is stored.

The program commands recorded in the computer readable storage medium are specially designed and configured according to the exemplary embodiment, but they are known and useable to a person having ordinary skill in a software field.

For example, the computer readable recording media include hardware devices configured to store and perform the program commands, such as magnetic media like a hard disk, floppy disk, and a magnetic tape, optical media like CD-ROM and DVD, magneto-optical media like floptical disk, ROM, RAM, and flash memory. Further, the computer readable recording media are distributed to computer systems connected through network and store and perform computer readable codes in such distribution way.

Examples of the program commands include machine codes made by a compiler as well as high-level language codes executed by a device for electronically processing information by an interpreter, such as a computer.

The hardware devices are operated with one or more software modules for performing the operations of the exemplary embodiment and vice versa.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An image processing method, comprising:
checking pixel data of at least one influencing pixel of a first pixel in an image, the at least one influencing pixel comprising pixels surrounding around the first pixel;
determining the quantization/inverse quantization values of the first pixel based on the pixel data of the at least one influencing pixel through the image processing system; and
performing quantization/inverse quantization for the first pixel.

2. The image processing method of claim 1, wherein the at least one influencing pixel is a decoding precedent pixel to the first pixel, the decoding precedent pixel being decoded before decoding the first pixel of the image.

3. The image processing method of claim 1, wherein the determining of the quantization/inverse quantization values of the first pixel comprises determining the quantization/inverse quantization values of the first pixel in proportion to a degree of complexity of an area corresponding to the influencing pixel.

4. The image processing method of claim 1, further comprising:
checking pixel data of at least one secondary influencing pixel of a subsequent pixel in the image, the subsequent pixel being quantized/inversely quantized directly after the quantization of the first pixel and the at least one secondary influencing pixel comprising pixels surrounding around the subsequent pixel; and
determining the quantization/inverse quantization values of the subsequent pixel based on the pixel data of the at least one secondary influencing pixel through the image processing system.

5. The image processing method of claim 1, wherein the image processing system performs a non-transformation process for the pixel data of the image.

6. An image processing method, comprising:
checking pixel data of at least one influencing pixel comprising decoding precedent pixels to a first pixel in an image;
determining quantization/inverse quantization values of the first pixel based on the pixel data of the at least one influencing pixel through the image processing system; and.
performing quantization/inverse quantization for the first pixel.

7. A non-transitory computer-readable storage medium having stored thereon processor-executable instruction configured to cause a processor to perform the image processing method of claim 1.

8. A non-transitory computer-readable storage medium having stored thereon processor-executable instruction configured to cause a processor to perform the image processing method of claim 2.

9. A non-transitory computer-readable storage medium having stored thereon processor-executable instruction configured to cause a processor to perform the image processing method of claim 3.

10. A non-transitory computer-readable storage medium having stored thereon processor-executable instruction configured to cause a processor to perform the image processing method of claim 4.

11. A non-transitory computer-readable storage medium having stored thereon processor-executable instruction configured to cause a processor to perform the image processing method of claim 5.

12. A non-transitory computer-readable storage medium having stored thereon processor-executable instruction configured to cause a processor to perform the image processing method of claim 6.

13. An image processing system, comprising:
a processor; and
a memory configured to store a processor-executable instruction,
wherein the processor-executable instruction is configured to cause a processor to:
check pixel data of at least one influencing pixel of a first pixel in an image, the at least one influencing pixel comprising pixels surrounding around the first pixel;
determine the quantization/inverse quantization values of the first pixel based on the pixel data of the at least one influencing pixel; and
perform quantization/inverse quantization for the first pixel.

14. An image processing system, comprising:
a processor; and
a memory configured to store a processor-executable instruction,
wherein the processor-executable instruction is configured to cause a processor to:
check pixel data of at least one influencing pixel comprising decoding precedent pixels to a first pixel in an image;
determine quantization/inverse quantization values of the first pixel based on the pixel data of the at least one influencing pixel; and
perform quantization/inverse quantization for the first pixel.
